(19) United States
(12) Patent Application Publication
(10) Pub. No.: US 2010/0051632 A1
(43) Pub. Date: Mar. 4, 2010

(54) Beverage Determination Indicator

(76) Inventor: Simone Mayer, Miami Shores, FL (US)

Correspondence Address: PROSKAUER ROSE LLP, ONE INTERNATIONAL PLACE, BOSTON, MA, 02110, US

(21) Appl. No.: 12/201,440

(22) Filed: Aug. 29, 2008

(51) Int. Cl. B65D 90/00; G09F 3/00

(52) U.S. Cl. 220/737; 220/694; 40/299.01

(57) ABSTRACT

A beverage indicator is provided. More particularly, a dual-sided indicator with a distinct pattern on each side is provided. The distinct pattern indicates the beverage served to a patron so an appropriate refill can be provided by the server.

### FIELD OF THE INVENTION

The invention generally relates to a beverage determination indicator and its use.

### BACKGROUND OF THE INVENTION

Coasters are commonly used in a variety of places such as bars and restaurants. Coasters are used by the wait staff to place the containers when serving beverages to patrons at these places. Typically, coasters serve to protect the surface of a table or counter from spilled beverages or water rings formed due to moisture condensation on the outside of the container.

It is a common custom at several such bars and restaurants to serve the patrons with refills of the beverage. Typically, the wait staff attends to numerous patrons at any given time and therefore it is very difficult to keep track of the type of beverage served to each individual patron. As a result, the server has to refer to the prior order or ask the patron for the information.

### SUMMARY OF THE INVENTION

In one aspect, the invention features a method of using a beverage indicator. The method includes serving a drink to a patron adjacent to an indicator that includes a pattern on at least one side. The pattern indicates the drink being served. The method further includes providing the patron with a refill of the drink as indicated by the pattern on the indicator.

In another aspect, the invention features a beverage indicator that includes means for identifying a type of beverage served to a patron. The invention also features a beverage indicator that includes means for indicating which of a plurality of beverages is being consumed.

In yet another aspect, the invention features a dual-sided beverage indicator. The indicator includes a first side that further includes a first pattern representative of a first beverage. The indicator also includes a second side that further includes a second pattern different than the first pattern. The second pattern is representative of a second beverage different than the first beverage.

In various examples, any of the aspects above or any of the methods or embodiments described herein, can include one or more of the following features. In some embodiments, the method can include providing a dual-sided indicator. In certain embodiments, each side of the indicator can include a distinct pattern. In various embodiments, the method can include inverting the indicator to reveal a different pattern.

In some examples, the pattern can include texture, color, design, shape or any combination thereof. In certain examples, the pattern can indicate a carbonated or non-carbonated drink. In various examples, the pattern can indicate an alcoholic or non-alcoholic drink.

In some embodiments, the pattern can indicate a hot or cold drink. In certain embodiments, the pattern can indicate a caffeinated or non-caffeinated drink. In various embodiments, the pattern can indicate a regular or diet drink.

In some examples, the means for identifying the type of beverage can include a pattern on at least one side of the indicator. In certain examples, the means can include a dual-sided indicator. In various examples, each side of the indicator can include a distinct pattern.

In some examples, the beverage indicator can be a coaster. In certain examples, the beverage indicator can be a chip. In various examples, the beverage indicator can be placed adjacent to the drink being served. In some examples, the beverage indicator can be placed under the drink being served. In certain examples, the beverage indicator can be placed beside, next to, on top of, or in proximity of the drink being served.

One advantage is that the pattern on the indicator can be used to distinguish the drinks served to patrons. When two different drinks have a similar appearance for example, regular soda and diet soda, a different side of the indicator can be used for each different drink. This allows a server to easily identify the drink by simply looking at the pattern on the indicator. Another advantage is when the containers used to serve two different drinks have a similar appearance. For example two coffee mugs containing coffee are served where one of the beverages is decaffeinated. Again, the server can distinguish between the two beverages based on the pattern on the indicator adjacent to the coffee mugs. Another advantage is when a server has to provide refills to patrons. For example when an alcoholic drink and a non-alcoholic drink are served in similar looking containers. The server can distinguish between the two drinks and provide refills as necessary without having to interrupt the patrons. Yet another advantage is when regular water and sparkling water are served to patrons in two separate but similar glasses. As the glasses become empty, a server can serve a refill based on the pattern on the indicator adjacent to the glasses.

Other aspects and advantages of the invention will become apparent from the following drawings, detailed description, and claims, all of which illustrate the principles of the invention, by way of example only.

### BRIEF DESCRIPTION OF DRAWINGS

FIG. 1 shows an example of a circular dual-sided indicator with a distinct pattern on one side where the pattern is a design.

FIG. 2 shows an example of a circular dual-sided indicator with a distinct pattern on each side where the pattern is a design.

FIG. 3 shows an example of a circular dual-sided indicator with a distinct pattern on each side where the pattern is a color.

FIG. 4 shows an example of a square dual-sided indicator with a distinct pattern on each side where the pattern is a texture.

FIG. 5 shows an example of a polygonal dual-sided indicator with a distinct pattern on each side where the pattern is a design.

FIG. 6 shows an example of a circular dual-sided indicator with a distinct pattern on each side where the pattern is a shape.

FIG. 7 shows an example of a circular dual-sided indicator with a distinct pattern on one side where the pattern is a letter.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

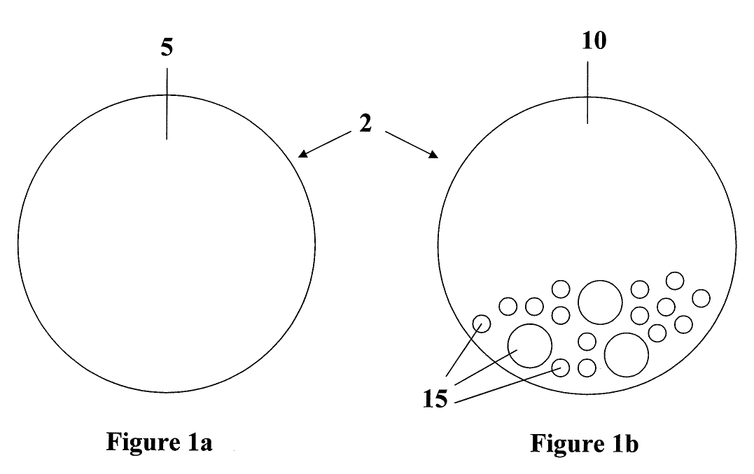

FIG. 1 shows an example of a circular dual-sided indicator with a distinct pattern on one side where the pattern is a design. Indicator 2 is circular and includes a first side 5 (FIG. 1a) and a second side 10 (FIG. 1b). The first side 5 can be distinguished from the second side 10 due to the pattern 15 on the second side 10. When serving two different beverages, for example plain water and sparkling water, to patrons in the same water glasses, a server can place the water glasses adjacent to a specific side of the dual-side indicator 2. The server can then serve refills as desired based on the pattern or the lack thereof. For example, if the patron is drinking flat or tap water the server can flip the indicator 2 so that the first side 5 is showing. For another patron drinking sparkling water, the server can flip the indicator 2 so that the second side 10 is showing.

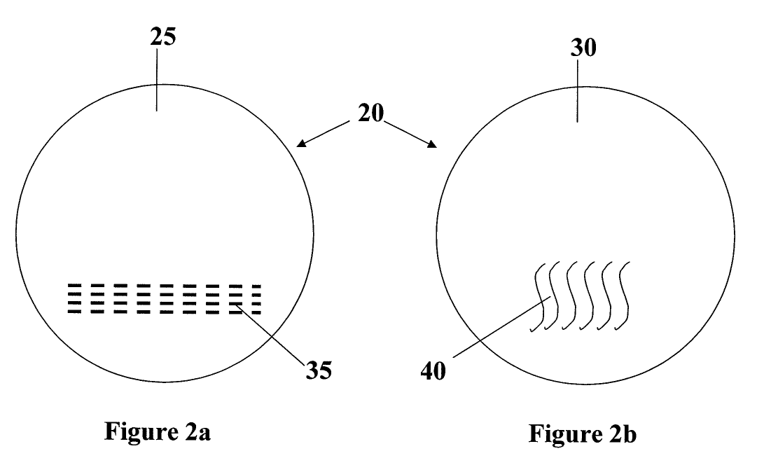

FIG. 2 shows an example of a circular dual-sided indicator with a distinct pattern on each side where the pattern is a design. Dual-sided indicator 20 is circular and includes a first side 25 (FIG. 2a) and a second side 30 (FIG. 2b). The first side 25 includes a design 35 to indicate, for example, a beverage at ambient temperature. The second side 40 includes a design 40 to indicate, for example, a hot beverage. For example, if the patron is drinking cold milk the server can flip the indicator 20 so that the first side 35 is showing. For another patron drinking warm milk, the server can flip the indicator 20 so that the second side 30 is showing.

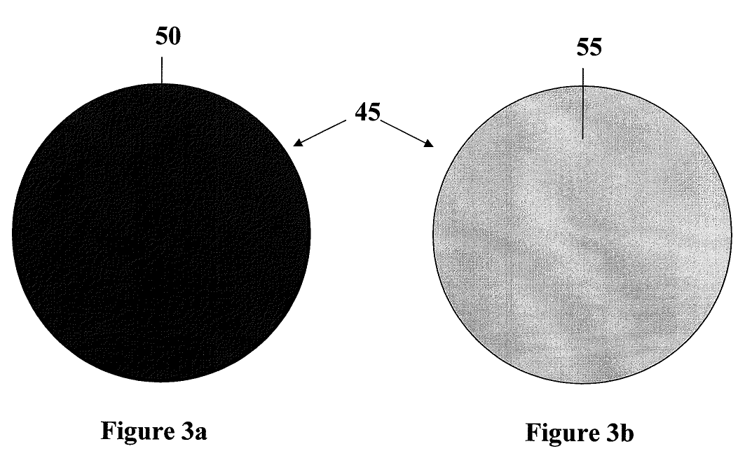

FIG. 3 shows an example of a circular dual-sided indicator with a distinct pattern on each side where the pattern is a color. Dual-sided indicator 45 is circular and includes a first side 50 (FIG. 3a) and a second side 55 (FIG. 3b) in different colors respectively. The different colors can be used to indicate different beverages served to patrons. For example, if the patron is drinking colorless soda the server can flip the indicator 45 so that the first side 50 is showing. For another patron drinking sparkling water, the server can flip the indicator 45 so that the second side 55 is showing.

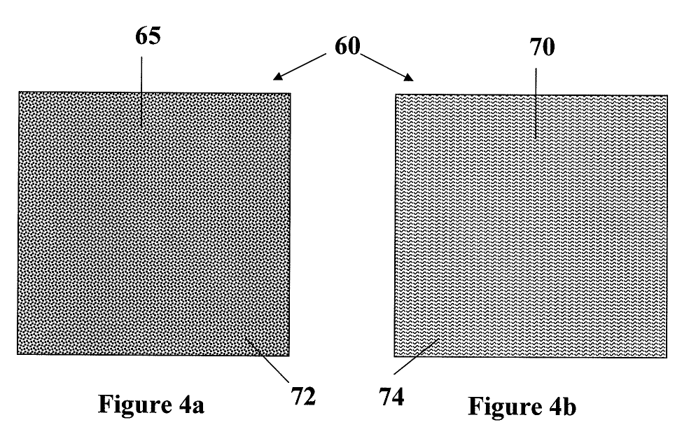

FIG. 4 shows an example of a square dual-sided indicator with a distinct pattern on each side where the pattern is a texture. Dual-sided indicator 60 is square and includes a first side 65 (FIG. 4a) and a second side 70 (FIG. 4b), each containing visually distinguishable textures 72 and 74. The textures 72 and 74 can be used to indicate different beverages served to patrons. For example, if the patron is drinking caffeinated soda the server can flip the indicator 60 so that the first side 65 is showing. For another patron drinking non-caffeinated soda, the server can flip the indicator 60 so that the second side 70 is showing.

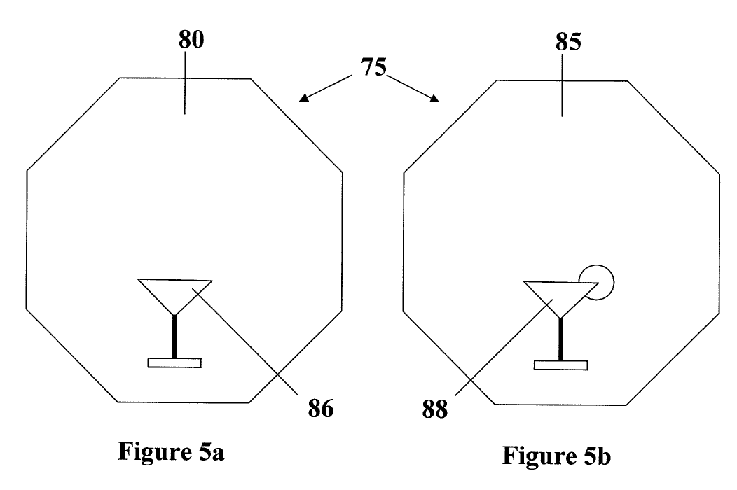

FIG. 5 shows an example of a polygonal dual-sided indicator with a distinct pattern on each side where the pattern is a design. Dual-sided indicator 75 is polygonal and includes a first side 80 (FIG. 5a) and a second side 85 (FIG. 5b). Each side can include a different design, for example 86 and 88, to indicate an alcoholic or a non-alcoholic drink. For example, if the patron is drinking a cocktail the server can flip the indicator 75 so that the first side 80 is showing. For another patron drinking a non-alcoholic virgin cocktail, the server can flip the indicator 75 so that the second side 85 is showing.

The beverage indicator can be placed adjacent to the drink being served. The term “adjacent to” can include under, beside, next to, on top of, or in proximity of the drink being served. For example, when a beverage coaster is used as the indicator, it can be placed under, or on top of the drink being served. When a chip is used as the indicator, it can be placed beside, next to or in proximity of the drink being served. In various embodiments, the indicator can be placed about 0.001-24 inches of the drink being served.

A variety of materials can be used to make the beverage indicator. In some embodiments, metals, metal alloys, wood, polymers, glass, ceramic or stone can be used. In certain embodiments, composite material such as plywood, paper, cardboard, fabric, leather, or rubber can be used. In various embodiments, any combination of the above mentioned materials can be used. Other materials known in the art to make beverage indicators can also be used. The material can be porous, non-porous, moisture absorbent or moisture proof. The material can have any property known in the art and commonly used for making beverage coasters.

In some embodiments, the materials can be blended or mixed together to make the indicators. In certain embodiments, the materials can be stacked over each other in a plurality of layers. For example, an indicator can be made of three different layers. The top layer can be made of moisture absorbent material such as fabric. The bottom layer can be made of skid resistant material such as rubber or a synthetic polymer. The center layer can be made of insulating material such as wood. In certain embodiments, a middle layer can include a compartment that can include air or can be evacuated. Materials that can provide durability and/or contain properties such as for example, scratch resistance, heat resistance, attractive appearance, etc. can be used.

The indicator can be of any shape, size or color. For example, the indicator can be circular, oval, triangular, square or polygonal. The indicator can have a diameter, length, breadth, or width of about 0.001-5.0 inches. In some embodiments, the indicator can have a diameter, length, breadth, or width of 1.0-4.0 inches. In certain embodiments, the indicator can have a diameter, length, breadth, or width of 2.0 inches. Although other dimensions are possible can be used if desired. The indicator can be made of any desired color. The two sides of a dual-sided indicator can have the same color, or they can have a different color.

Each side of the indicator can include a textured surface. The texture may be due to the type of material used to make the indicator. In some embodiments, a desired texture can be created on each side of the indicator by suitable instruments commonly used for such purposes.

Each side of the indicator can include a design. The design can include for example, a company logo. In some embodiments, the design can represent the type of drink that is served to a patron. A design can be applied for example, as a sticker. A design can be drawn, painted, printed, embossed or carved onto each side of the indicator if desired. A design can also be a part of the material used to make the indicator. Any methods commonly used by a person of skill in the art can be employed to get the desired design on a side of the indicator.

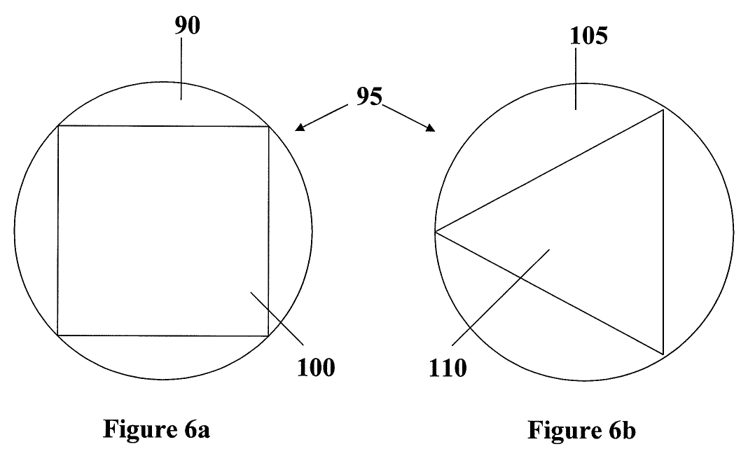

FIG. 6 shows an example of a circular dual-sided indicator with a distinct pattern on each side where the pattern is a shape. Each side of the indicator can have a different shape if desired. As shown in FIG. 6a, a first side 90 of indicator 95 can have a square 100. As shown in FIG. 6b, a second side 105 of indicator 95 can have a triangle 110. A shape can be applied for example, as a sticker. A shape can be drawn, painted, printed, embossed or carved onto each side of the indicator if desired. A shape can also be a part of the material used to make the indicator. Any methods commonly used by a person of skill in the art can be employed to get the desired shape on a side of the indicator.

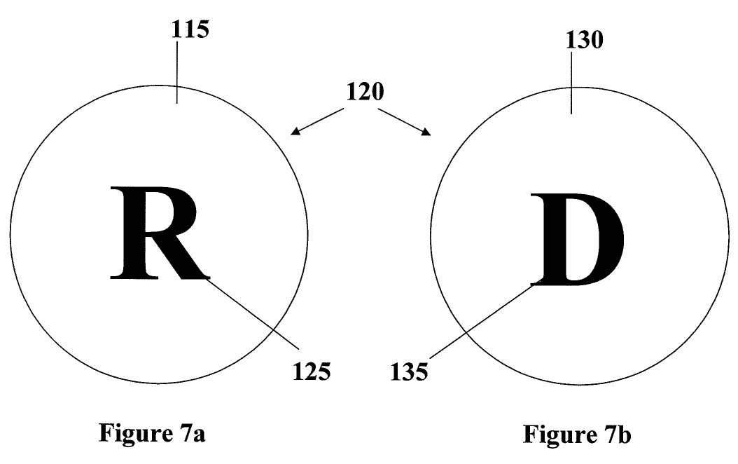

FIG. 7 shows an example of a circular dual-sided indicator with a distinct pattern on each side where the pattern is a letter. Each side of the indicator can have a different letter if desired. As shown in FIG. 7a, a first side 115 of indicator 120 can have a letter “R” 125. As shown in FIG. 7b, a second side 130 of indicator 120 can have a letter “D” 135. A letter can be applied for example, as a sticker. A letter can be drawn, painted, printed, embossed or carved onto each side of the indicator if desired. A letter can also be a part of the material used to make the indicator. Any methods commonly used by a person of skill in the art can be employed to get the desired letter on a side of the indicator.

When serving two different beverages, for example regular and decaffeinated coffee, to patrons in similar looking coffee mugs, a server can place the coffee mugs adjacent to a specific side of the dual-side indicator 120. The letter “R” can indicate for example a regular or caffeinated drink. The letter “D” can indicate for example a non-caffeinated or decaffeinated drink. The server can then serve refills as desired based on the letter on the indicator. For example, if one patron is drinking sparkling water or a carbonated drink the server can use an indicator with the letter “S” or “C” respectively on one side. For another patron drinking flat water or drink, the server can flip the indicator so that the second side with a letter “F” is showing.

The indicator can be used by, for example, a server serving drinks to patrons in a restaurant. The server can place a drink adjacent to a particular side of the indicator depending on the type of drink ordered by the patron associated with that indicator. The server can then refer to the pattern on the side of the indicator adjacent to the drink container to identify each drink and to distinguish each drink from another, served at the same table. Once the drink is identified, refills to the drink can be provided as indicated by the pattern on the side of the indicator, without having to ask the patron what they are or were drinking.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

What is claimed is:

1. A method of using a beverage indicator comprising:
a) serving a drink to a patron adjacent to an indicator comprising a pattern on at least one side of the indicator, wherein the pattern indicates the drink being served; and
b) providing the patron with a refill of the drink as indicated by the pattern on the indicator.

2. The method of claim 1 further comprising providing a dual-sided indicator.

3. The method of claim 2 wherein each side of the indicator comprises a distinct pattern.

4. The method of claim 1 further comprising inverting the indicator to reveal a different pattern.

5. The method of claim 1 wherein the pattern comprises texture, color, design, shape or any combination thereof.

6. The method of claim 1 wherein the pattern indicates a carbonated or non-carbonated drink.

7. The method of claim 1 wherein the pattern indicates an alcoholic or non-alcoholic drink.

8. The method of claim 1 wherein the pattern indicates a hot or cold drink.

9. The method of claim 1 wherein the pattern indicates a caffeinated or non-caffeinated drink.

10. The method of claim 1 wherein the pattern indicates a regular or diet drink.

11. The method of claim 1 wherein the beverage indicator is a coaster or a chip.

12. A beverage indicator comprising means for identifying a type of beverage or means for indicating which of a plurality of beverages is being consumed.

13. The beverage indicator of claim 12 wherein the means comprises a pattern on at least one side of the indicator.

14. The beverage indicator of claim 12 wherein the means comprises a dual-sided indicator.

15. The beverage indicator of claim 14 wherein each side of the indicator comprises a distinct pattern.

16. The beverage indicator of claim 15 wherein the pattern comprises texture, color, design, shape or any combination thereof.

17. The beverage indicator of claim 15 wherein the pattern indicates a carbonated or non-carbonated drink.

18. The beverage indicator of claim 15 wherein the pattern indicates an alcoholic or non-alcoholic drink.

19. The beverage indicator of claim 15 wherein the pattern indicates a hot or cold drink.

20. The beverage indicator of claim 15 wherein the pattern indicates a caffeinated or non-caffeinated drink.

21. The beverage indicator of claim 15 wherein the pattern indicates a regular or diet drink.

22. The beverage indicator of claim 15 wherein the indicator is a coaster or a chip.

23. A dual-sided beverage indicator comprising a first side comprising a first pattern representative of a first beverage, and a second side comprising a second pattern different than the first pattern, representative of a second beverage different than the first beverage.
